(19) United States
(12) Patent Application Publication
(10) Pub. No.: US 2019/0302903 A1
(43) Pub. Date: Oct. 3, 2019

(54) SIX DOF INPUT DEVICE

(71) Applicant: Microsoft Technology Licensing, LLC, Redmond, WA (US)

(72) Inventors: Charlene Mary ATLAS, Redmond, WA (US); Ishac BERTRAN, Seattle, WA (US); Benjamin Hunter BOESEL, Seattle, WA (US); Lorenz Henric JENTZ, Seattle, WA (US); Nikolai Michael FAALAND, Sammamish, WA (US); Christian KLEIN, Duvall, WA (US); Xin Xian LIANG, Renton, WA (US); Orr SROUR, Ramat-Hasharon (IL)

(73) Assignee: Microsoft Technology Licensing, LLC, Redmond, WA (US)

(21) Appl. No.: 15/942,100

(22) Filed: Mar. 30, 2018

(51) Int. Cl. G06F 3/0346; G06F 3/0354

(52) U.S. Cl. CPC G06F 3/0346; G06F 3/03545

(57) ABSTRACT

Examples are disclosed herein that relate to a six degree-of-freedom (DOF) input device. An example provides an input device comprising a body, a sensor system configured to sense motion of the input device with six DOF, a communication interface and a controller. The controller is configured to transmit output based on sensor data from the sensor system for use in controlling an application in a first mode in which each of the six degrees-of-freedom is used as input, the application being controlled in the first mode in response to detecting a first condition, and transmit output based on sensor data from the sensor system for use in controlling the application in a second mode in which one or more of the six degrees-of-freedom is not used as input, the application being controlled in the second mode in response to detecting a second condition.

### BACKGROUND

Input devices may facilitate different types of user interaction with a computing device. As examples, two-dimensional translation of a computer mouse across a surface may cause two-dimensional translation of a cursor on a display, while a handheld controller equipped with an inertial measurement unit may provide three-dimensional input as the controller is manipulated throughout space.

### BRIEF DESCRIPTION OF THE DRAWINGS

FIGS. 1A-1D illustrate various example modes of user interaction carried out between an input device and a computing device.

FIG. 2 shows a block diagram of an example input device.

FIG. 3 shows an example input device in the form of a stylus.

FIGS. 4A-4B illustrate the control of a virtual camera in a three-dimensional scene by the stylus of FIG. 3.

FIG. 5 shows another example input device configured for use with the input device of FIGS. 1A-1D.

FIG. 6 shows a flowchart illustrating an example method of controlling an application in different modes using a six DOF input device.

FIG. 7 shows a block diagram of an example computing device.

### DETAILED DESCRIPTION

As described above, different input devices may facilitate different types of user interaction with a computing device. As examples, two-dimensional translation of a computer mouse across a surface may enable two-dimensional translation of a cursor on a display, while a handheld controller equipped with an inertial measurement unit may provide three-dimensional input as the controller is manipulated throughout space.

These and other existing input devices may present a variety of issues. First, a typical input device has a form factor that lends itself to being held or otherwise manipulated in particular ways. Other ways of manipulating the input device may be cumbersome or awkward, and when considered with the constrained nature of human wrist and arm movement, this can limit use of the input device. Second, typical input devices do not support easy/effective transitions among different paradigms of user interaction. This can hinder or prevent multi-modal interaction, further limiting the usefulness of the input device. As one example of multi-modal interaction, a user may want to animate a graphical object in three dimensions—itself often a challenging task due to the limitations of existing input devices and the two-dimensional nature of graphical output representing the object and its animation—as well as the ability to supply two-dimensional input to a graphical user interface. Users are increasingly interested in dynamically engaging in different paradigms of user interaction, particularly as mixed reality and other emerging computing experiences that involve three-dimensional content gain prominence.

In view of these and other issues, examples are described herein that relate to a six degrees-of-freedom (DOF) input device. As described in further detail below, output from the input device may be used in controlling an application in a first mode and second mode. In the first mode, each of the six degrees-of-freedom sensed by the input device may be used to control the application, whereas in the second mode, one or more of the six degrees-of-freedom may not be used to control the application. These and other modes may be switched among in response to detecting various conditions also described below.

Input devices disclosed herein may be conducive to manipulation with a greater variety of orientations and motions, supporting natural and expressive movement throughout space, to better enable various paradigms of user interaction. Further, examples disclosed herein may facilitate various types of multi-modal user interaction. As described below, multi-modal user interaction may include (1) translational and/or rotational three-dimensional manipulation of an input device throughout space, (2) two-dimensional translation of an input device across a surface, two-dimensional input applied to a touch-sensitive surface, (3) two-dimensional input applied to a graphical user interface, (4) single axis rotation, and/or (5) gestural input applied to an input device, among others. Further, the input device and supporting components may be configured to enable seamless switching among these modes to enable dynamic changes in user interaction. Additional examples are described herein that combine multiple input devices to enhance and/or refine user interaction. Further examples are disclosed that enhance visualization and interaction with three-dimensional graphical content.

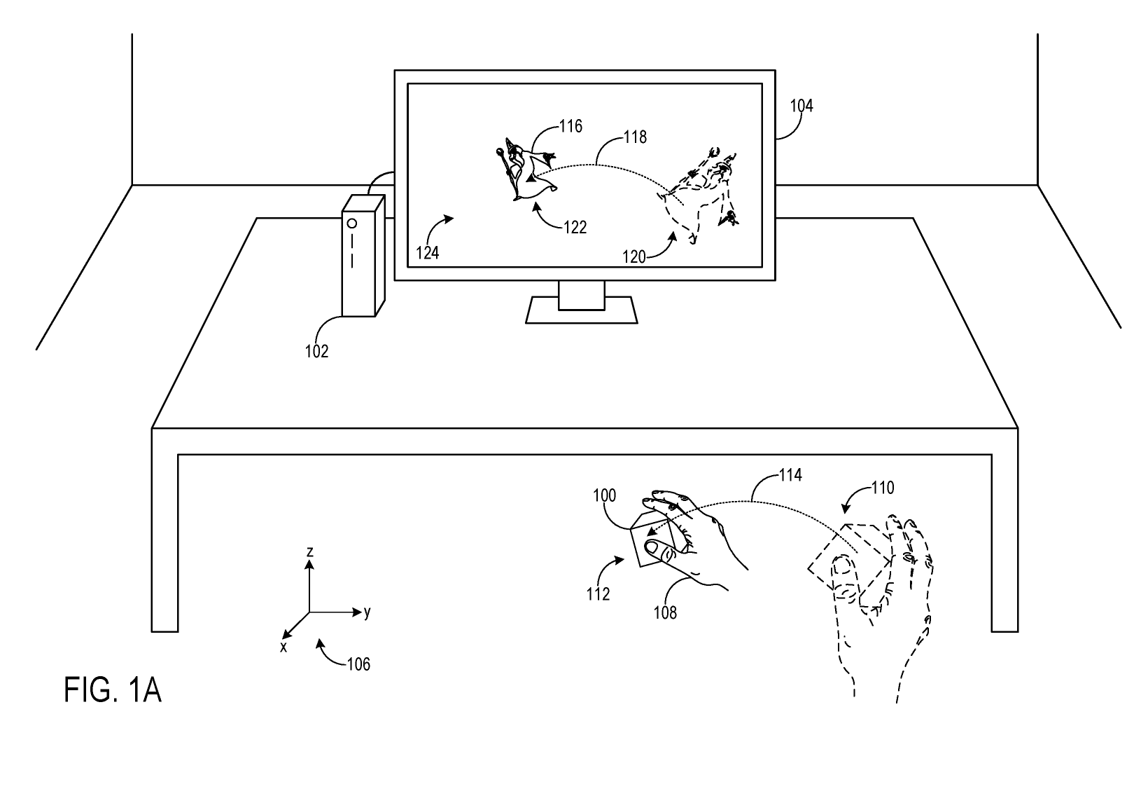

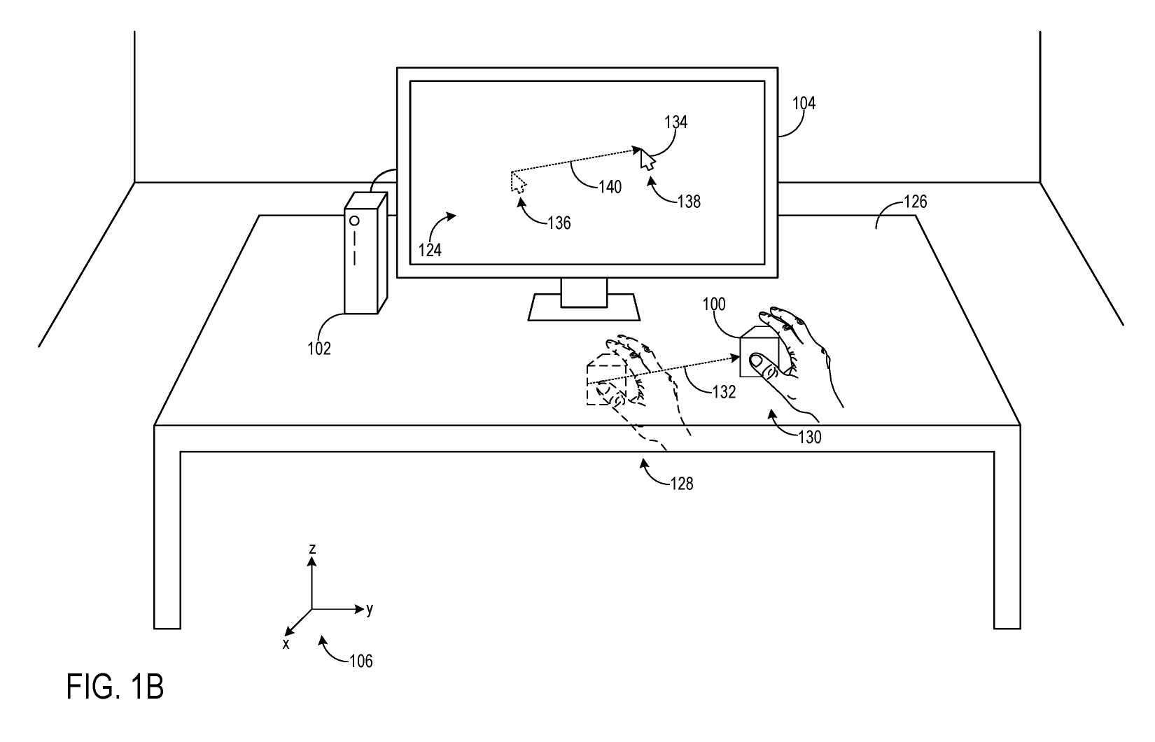

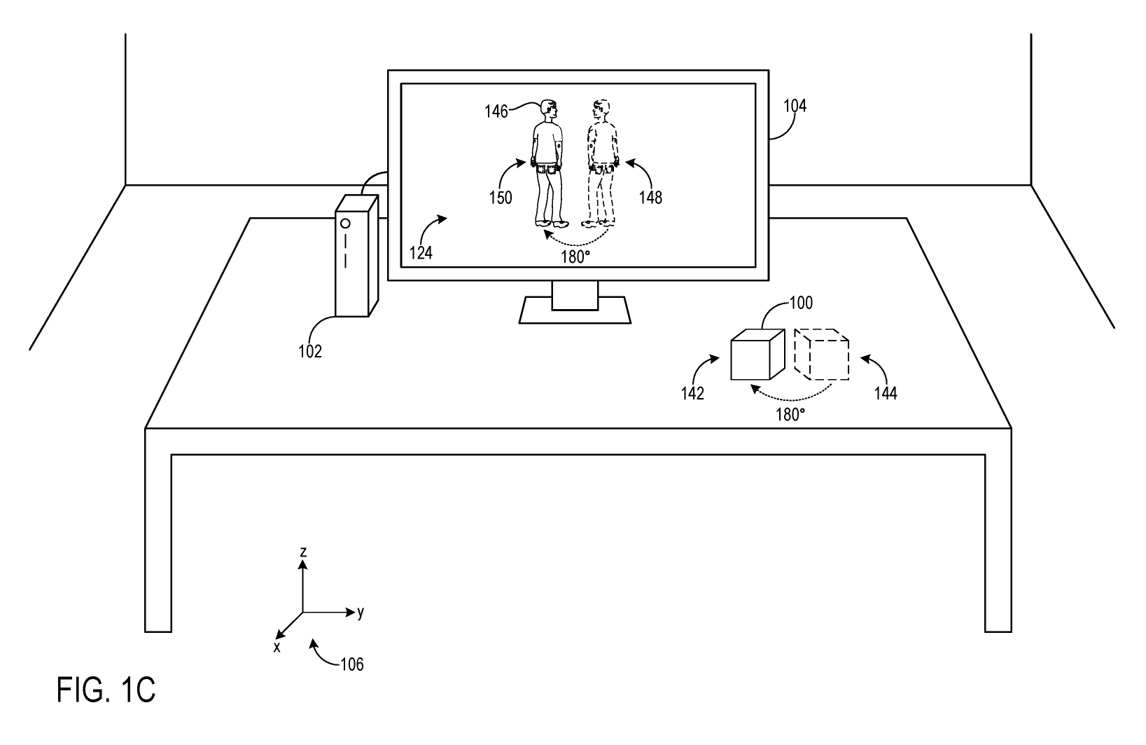

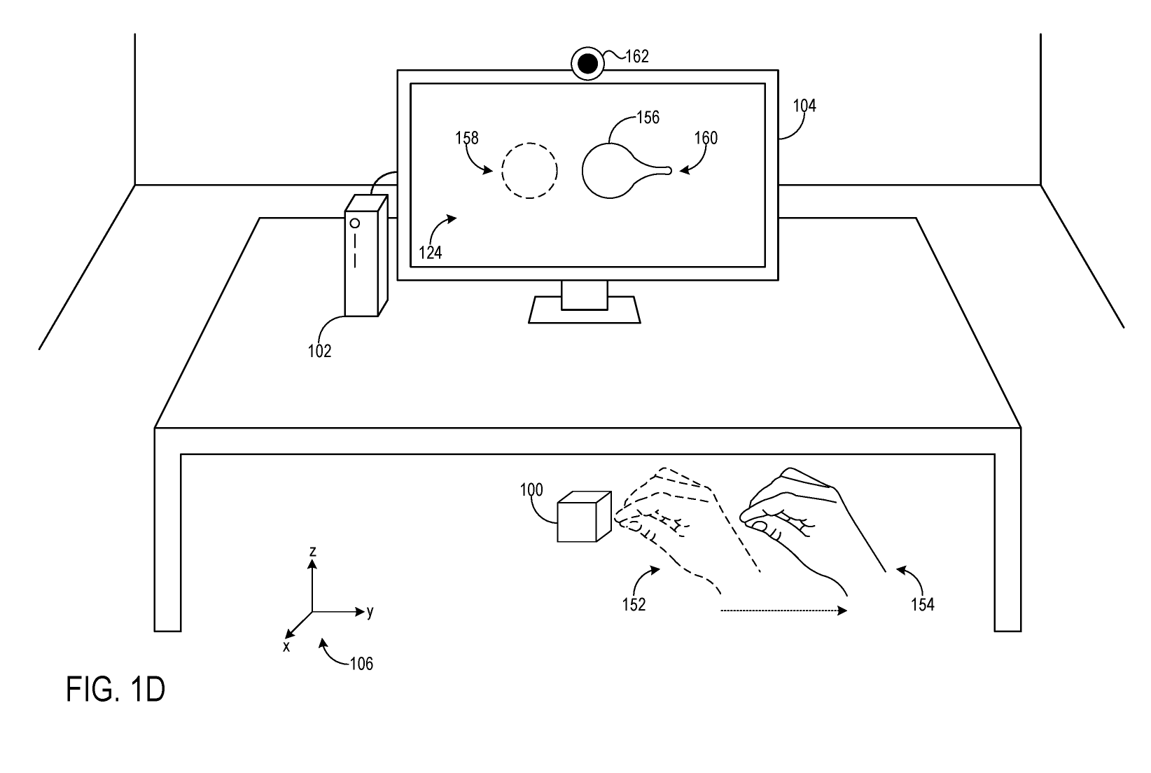

FIGS. 1A-D illustrate various example modes of user interaction carried out between an input device 100 and a computing device 102. In the example depicted in FIG. 1A, three-dimensional manipulation of input device 100 in physical space is used to affect the three-dimensional location and orientation of graphical content rendered on a display 104 coupled to computing device 102. As described in further detail below, input device 100 includes a sensor system that senses manipulation of the input device with six degrees-of-freedom: with reference to a Cartesian coordinate axis 106, the six degrees-of-freedom include three degrees of translational freedom respectively corresponding to the x, y, and z-axes, and three degrees of rotational freedom respectively corresponding to the x, y, and z-axes. The sensing of six degrees-of-freedom may enable translation of input device 100 along a given axis to effect translation of graphical content along an analogous axis on display 104, and rotation of the input device about a given axis to effect rotation of graphical content about an analogous axis. In this way, input device 100 may serve as a proxy for naturally manipulating graphical content in three dimensions.

As shown in FIG. 1A, input device 100 is translated in physical space by a user hand 108 from an initial location 110 to a final location 112 along a physical path 114. Input device 100 senses this translation and, via a communication interface described below, transmits data indicative of the manipulation to computing device 102. Based on this data, a virtual character 116 rendered on display 104 is translated along a display path 118 between an initial location 120 and a final location 122. Display path 118 may generally resemble physical path 114 in that translation of virtual character 116 resembles translation of input device 100—for example, the display path may be a scaled (e.g., reduced in magnitude) version of the physical path. Display path 118 may exhibit any suitable correspondence to physical path 114, however. Via display path 118, virtual character 116 is shifted leftward and reduced in apparent size to reflect the translation of the input device in the negative y direction (e.g., leftward) and in the negative x direction (e.g., into the page of FIG. 1A).

The three-dimensional rotational orientation of virtual character 116 is also adjusted to reflect the x-axis rotation of input device 100 from initial location 110 to final location 112. Here, virtual character 116 is also rotated about the x-axis between initial location 120 and final location 122. Virtual character 116 may exhibit substantially the same rotational orientation as that of input device 100, though any suitable correspondence may be established between the rotational orientation of graphical content and that of the input device.

Computing device 102 may reflect changes to the location and orientation of virtual character 116 in any suitable manner. In some examples, computing device 102 may animate in real-time the traversal of virtual character 116 along display path 118 as input device 100 traverses physical path 114. In this way, movement of virtual character 116 may appear to mimic that of input device 100, which may provide visual feedback that supports the use of the input device as a proxy for manipulating graphical content. Computing device 102 may update the location and/or orientation of graphical content in response to manipulation of input device 100 in any suitable manner, however.

Input device 100 may be used to control the three-dimensional location and/or orientation of graphical content in any suitable context. In FIG. 1A, virtual character 116 is rendered as part of an application 124 executing on computing device 102. In one example, application 124 may enable the animation of virtual character 116 and other virtual objects based on input provided by manipulating input device 100 in physical space. Here, the animation applied to virtual character 116 may include its traversal of display path 118, defined by physical path 114 as described above. Animation carried out with input device 100 may involve animating other aspects of graphical content, such as individual limbs/body parts/facial features of human and animal avatars, physical interactions between objects, etc. As further example contexts in which input device 100 may be used, such contexts may include computer-aided design, three-dimensional modeling, two-dimensional drawing, videogames, physical rehabilitation, control of a peripheral device such as the articulated arms of a robot, remote control of a vehicle such as an airborne drone, recording of spatial input, mapping of physical spaces, creation of virtual environments, and/or cycling through slides in a presentation and through other graphical user interface elements.

FIG. 1A represents examples in which motion in all six degrees-of-freedom sensed by input device 100 may be used to control an application executing on computing device 102. For application 124 and the animation of graphical content therein, motion of input device 100 in each degree-of-freedom may effect corresponding and potentially proportional motion of virtual character 116. In particular, translation of input device 100 along the x, y, and z-axes may cause translation of the virtual character along analogous x, y, and z-axes, respectively, in the display space of display 104. Further, rotation of input device 100 about the x, y, and z-axes may cause rotation of the virtual character about the analogous display space x, y, and z-axes, respectively. However, any suitable correspondence may be established between motion of input device 100 in physical space and motion of graphical content in display space. For example, motion of input device 100 in a particular degree-of-freedom may effect motion of virtual character 116 in a different degree-of-freedom.

In some examples, one or more of the six degrees-of-freedom of input device 100 may not be used as input in controlling application 124. To this end, FIG. 1B shows input device 100 being slid across a surface 126 from an initial location 128 to a final location 130 along a physical path 132. In response, a cursor 134 displayed in application 124 is translated from an initial location 136 to a final location 138 along a display path 140, which is selected based on physical path 132. Display path 140 may be substantially equal to physical path 132 in direction and scaled (e.g., reduced) in magnitude, for example. In this example, two-dimensional translation (e.g., along the x and y-axes) of input device 100 effects corresponding and potentially proportional two-dimensional translation of cursor 134. Manipulation of input device 100 in other degrees-of-freedom—e.g., any rotation, and/or translation along the z-axis—may not affect the position of cursor 134, however.

The use of a reduced set of degrees-of-freedom (e.g., less than all six degrees-of-freedom sensed by input device 100) in controlling an application may arise when the input device undergoes constrained motion. Constrained motion of input device 100 may include motion in which one or more of the six degrees-of-freedom of the input device remains substantially fixed (e.g., not including motion below a threshold), such as the two-dimensional motion constrained to surface 126 shown in FIG. 1B. The detection of constrained motion may prompt a switch at application 124 from a first mode, in which all six degrees-of-freedom sensed by input device 100 is used to control the application, to a second mode, in which one or more of the six degrees-of-freedom are not used to control the application. As one example, a transition from the manipulation of input device 100 in all six degrees-of-freedom in FIG. 1A to its two-dimensional translation constrained to surface 126 in FIG. 1B may be detected by observing that sensor data sensed by the input device in one or more degrees-of-freedom is substantially fixed. This may prompt the display of cursor 134 and enable its two-dimensional translation across display 104.

The detection of constrained motion of input device 100 may prompt any other suitable type of mode switch at application 124. In another example, cursor 134 may be displayed prior to the mode switch, and the detection of constrained motion may instead hand control by input device 100 to the translation of the cursor, and disable control of virtual character 116 by the input device. Yet other examples of mode switches prompted by the detection of constrained motion may include the display of a graphical user interface configured to receive two-dimensional input, or the display of graphical content configured for manipulation with input in the unconstrained degrees-of-freedom—e.g., those indicated by sensor data detected by input device 100 to be varying. Generally, the display of graphical content configured for input in the unconstrained degrees-of-freedom may include displaying a user interface, a menu option, a desktop window, a different application, files previously interacted with using the unconstrained degrees-of-freedom, a graphical indication of geometric attributes (e.g., axis/axes, plane(s), coordinates, distances, angles) corresponding to the unconstrained degrees-of-freedom, a graphical indication of a direction and/or magnitude associated with input provided by input device 100, a prompt indicating a mode switch or requesting user input that confirms and effects the mode switch, an image/animation/video that represents the input modalities available in the current mode (e.g., with examples of inputs such as gestures, potentially in the form of a tutorial), etc.

Other triggers that cause mode switches at application 124 are possible. In addition to a transition from fully unconstrained motion (e.g., all six degrees-of-freedom unconstrained) to constrained motion (e.g., one or more degrees-of-freedom constrained), a transition from constrained motion to fully unconstrained motion may also prompt a mode switch. Each unique combination of unconstrained/constrained degrees-of-freedom may be considered a condition detected as described below, such that a first condition may include variation of each degree-of-freedom, and a second condition may include one or more degrees-of-freedom being constrained.

Further, a change in which degrees-of-freedom are constrained may prompt a mode switch. For example, a user shifting input device 100 across surface 126 as shown in FIG. 1B may subsequently opt to provide constrained input in the form of one-dimensional input along the y-axis. As the user's arm may naturally shift in other degrees-of-freedom, motion detected in these degrees-of-freedom may be filtered out and not used as input to application 124, provided such motion remains under a threshold. In these and other examples, a mode switch may be automatically prompted by evaluating sensor data collected by input device 100 and determining which degrees-of-freedom are unconstrained/constrained. This may enable seamless transitions among different paradigms of user interaction. The determination of which degrees-of-freedom are unconstrained/constrained may take place at locations other than input device 100, however, as described below. In other examples, a mode switch may occur based on sensor data and explicit user input, which may support dynamic transitions among user interaction paradigms while avoiding undesired transitions due to a lack of knowledge regarding user intention. The user input may include but is not limited to an input (e.g., gesture) performed with or proximate to/in contact with input device 100, voice command, hand gesture, head gesture, gaze pattern, etc. In other examples, a mode switch may be performed based on a prediction based on past user behavior, previously-established user settings, time of day, current application, power state of input device 100, a signal from host device 102 instructing a mode switch, and/or any other suitable criteria.

FIG. 1C illustrates another example in which input device 100 is constrained. In the depicted example, input device 100 is rotated about the z-axis by 180 degrees from an initial rotational orientation 142 to a final rotational orientation 144. In response, a virtual character 146 rendered on display 104 is also rotated by 180 degrees from an initial rotational orientation 148 to a final rotational orientation 150. While the positions of input device 100 and virtual character 146 are shown as differing between their initial and final orientations for clarity, the input device and virtual character may purely undergo rotation about the z-axis without changes in any other degree-of-freedom.

Pure rotation about a single axis is another example of constrained motion of input device 100, resulting in the use of a reduced set of degrees-of-freedom in controlling application 124. In this case, application 124 does not use input in all six degrees-of-freedom sensed by input device 100, but only input in those degrees-of-freedom sensed as varying. Should motion occur in any other degree-of-freedom, application 124 may ignore such input provided the motion remains under a threshold. In some examples, detecting that input device 100 undergoes significant motion (e.g., motion above the threshold) in the form of single axis rotation may prompt a mode switch in application 124 enabling rotation of virtual character 146 and other graphical content along a single analogous axis. Other functionality of application 124 may be invoked in response to single axis rotation of input device 100, however, including translation of graphical content along a single axis.

In some examples, input device 100 may be used in conjunction with hand gestures in interacting with computing device 102. To this end, FIG. 1D depicts an example in which hand 108 performs a pinching hand gesture in relation to input device 100 (which may be held with another hand not shown in FIG. 1D). The hand gesture is started at an initial location 152 proximate to the surface of input device 100. While retaining the pinched posture, hand 108 moves in the positive y direction to a final location 154 away from input device 100. A virtual object 156 rendered on display 104 is controlled in response to this pinching hand gesture. As indicated at 158, FIG. 1D shows virtual object 156 in an initial state prior to the performance of the hand gesture, in which the virtual object exhibits a circular geometry. In response to the hand gesture, virtual object 156 is extruded to a magnitude proportional to that of the hand gesture, as indicated at 160.

Any suitable gesture may be performed in relation to input device 100, in response to which computing device 102 may take any suitable action. A gesture may be a one, two, or three-dimensional gesture. As another example, input device 100 may be used as a proxy for controlling the three-dimensional location and orientation of a virtual object, and hand gestures performed within a threshold distance of the input device may effect various actions applied to the virtual object. Further, touch input applied to the surface of input device 100 may be used as input to computing device 102. As one example, a user may apply two-dimensional imagery (e.g., writing, drawings) to a virtual object by tracing the imagery with touch input applied to input device 100, which may serve as a surrogate for controlling the virtual object. As used herein, “gestural input” may refer to both hand gestures performed proximate to an input device as well as touch input applied by contacting the input device.

To enable the detection of gestural input applied to input device 100, the input device may include a suitable touch/hover sensing system. The sensing system may utilize any suitable sensing technologies, including but not limited to capacitive, resistive, optical, and acoustic sensors. Alternatively or additionally, an image sensor external to input device 100 may be used to detect gestural input supplied in relation to the input device. To this end, FIG. 1D shows an image sensor 162 coupled to computing device 102 and configured to detect gestural input applied to input device 100. Image sensor 162 may assume any suitable form, such as that of a depth camera (e.g., time-of-flight, structured light, stereo camera system).

Image sensor 162 may be utilized for other purposes. In some examples, input device 100 may omit the inclusion of a sensor system for sensing its manipulation in six degrees-of-freedom, which may instead be implemented by image sensor 162. In other examples, input device 100 may include a six degrees-of-freedom sensor system producing output that is analyzed at computing device 102 along with output from image sensor 162 to refine tracking of the input device. This strategy may help compensate for sensor drift occurring during translation of input device 100, for example. Moreover, input device 100 (e.g., based on output from the six DOF sensor system and/or a gesture sensor) and/or image sensor 162 may detect if the input device is being held or generally manipulated. When input device 100 is not held, the input device may turn off active component(s) therein, for example, to reduce power consumption and battery life, for examples in which the input device includes a battery. Further, the differentiation of whether input device 100 is held may be used as an input to application 124—e.g., to prompt an appropriate mode switch, enable control of graphical content.

Gaze input provided by a user's eyes may augment interaction carried out with input device 100. Gaze detection may be implemented on image sensor 162, though a dedicated gaze tracking machine may be used to perform gaze detection. In one example, the gaze tracking machine may be integrated in a head-mounted display (HMD) device. While shown in the form of a computer monitor, display 104 may be implemented as an integrated display in the HMD device, for example. Application 124 may utilize gaze input in any suitable manner. For example, computing device 102 may determine gaze vector(s) projected from one or both of a user's eyes to display 104, and identify a virtual object intersected by the gaze vector(s). Computing device 102 may then apply input provided via input device 100 to the identified object. Alternatively or additionally, gaze input may prompt a mode switch at application 124.

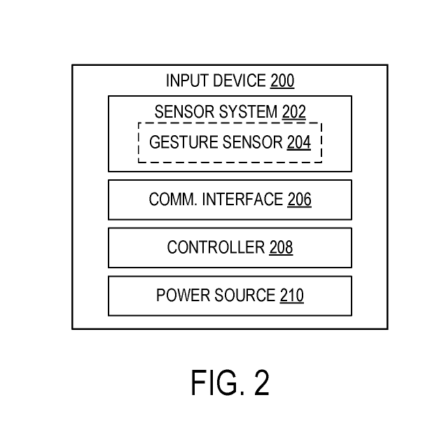

Turning now to FIG. 2, a block diagram of an example input device 200 is shown. Input device 100 of FIGS. 1A-1D may implement at least some of the components of input device 200, for example. Input device 200 may include a sensor system 202 for sensing manipulation of the input device in physical space. Sensor system 202 may sense motion of input device 200 with six degrees-of-freedom: three degrees of translational freedom (e.g., along orthogonal x, y, z axes) and three degrees of rotational freedom (e.g., about orthogonal x, y, z axes). Sensor system 202 may assume any suitable form, such as that of an inertial measurement unit (IMU), and may include one or more of an accelerometer, gyroscope, and magnetometer. As another example, sensor system 202 may perform six DOF sensing based on alternating current electromagnetic sensing technology.

For examples in which input device 200 is operable to sense gestural input, sensor system 202 may include a gesture sensor for sensing such gestural input. The gesture sensor may include capacitive, resistive, optical, acoustic, and/or any other suitable sensing technologies.

Input device 200 may include a communication interface 206. Interface 206 may enable input device 200 to couple with a host device such as computing device 102, and enable the transmission of output based on sensor data collected by sensor system 202. The output may be used to control an application such as application 124 as described above. Interface 206 may be a wired and/or wireless communication interface, and may take any suitable form, such as that of a universal serial bus (USB) interface, a Bluetooth interface, a Wi-Fi interface, etc.

Input device 200 may include a controller 208. Controller 208 may at least partially enable the operation of the one or more components implemented in input device 200. Further, controller 208 may cause the transmission of output based on sensor data collected by sensor system 202 to a host device, via communication interface 206. As described above, such output may be used to control an application such as application 124 in different modes. The output may assume any suitable form. In some examples, the output may indicate motion of input device 200 independently for each degree-of-freedom sensed by sensor system 202. With sensor system 202 configured to sense motion in six degrees-of-freedom, the output may include respective indications of translational motion along three orthogonal coordinate axes, and respective indications of rotational motion along the three orthogonal coordinate axes, for example. An indication of motion may include a speed, velocity, acceleration, scalar, vector, and/or any other suitable parameter.

Like input device 100, input device 200 may produce output used to control an application in a first mode where motion in all sensed degrees-of-freedom is used as input to the application. Input device 200 may also produce output used to control the application in a second mode (and potentially other modes) where motion in a reduced set of degrees-of-freedom—i.e., not all of the sensed degrees-of-freedom—is used as input to the application. The application may be controlled in the first mode in response to detecting variation in each degree-of-freedom, while being controlled in the second mode in response to detecting that one or more of the degrees-of-freedom are constrained. This detection may be implemented in various manners.

In one example, controller 208 may determine which degrees-of-freedom are unconstrained and which degrees-of-freedom are constrained by analyzing the motion indicated by sensor system 202 in each degree-of-freedom. Motion in a first degree-of-freedom equal to or greater than a threshold may be interpreted as indicating that the first degree-of-freedom is unconstrained, while motion in a second degree-of-freedom below the threshold may be interpreted as indicating that the second degree-of-freedom is constrained. Averaging, filtering, and/or any other suitable processing may be applied to output from sensor system 202 in assessing motion. In response to distinguishing the unconstrained degrees-of-freedom from the constrained degrees-of-freedom, controller 208 may then transmit, via communication interface 206, output indicating motion in only the unconstrained degrees-of-freedom to a host device. The application may then utilize output corresponding to only the unconstrained degrees-of-freedom as controlling input. By restricting data transmission from input device 200 based on which degrees-of-freedom are unconstrained, power consumption by the input device, the potential for signal interference, and/or data processing by the input device and/or a host device may be reduced.

In other examples, input device 200 may forego the determination of which degrees-of-freedom are unconstrained and constrained, and transmit output corresponding to all sensed degrees-of-freedom. The host device may then filter out data corresponding to the constrained degrees-of-freedom. Such filtering may be implemented at any suitable location on the host device, such as at firmware of the host device, an operating system executing on the host device, the application receiving the output, etc. In some examples the host device may optionally transmit a signal to input device 200 causing the input device to cease transmission of output corresponding to the constrained degrees-of-freedom. Further, examples are possible in which input device 200 and/or the host device distinguish between constrained and unconstrained degrees-of-freedom, with the host device transmitting a signal to the input device causing the input device to cease processing input in the constrained degrees-of-freedom and/or potentially the distinguishing between unconstrained/constrained degrees-of-freedom. Still other mechanisms may control how output corresponding to constrained degrees-of-freedom is reported to the application—for example, user input may specify how the output is reported. Such user input may be received via settings menu provided by the host device that allows the establishment of user preferences for input device 200 and/or the application, for example.

Input device 200 may include or otherwise couple to a power source 210 configured to power one or more components of the input device. Power source 210 may include a battery, for example, which may be removable and/or rechargeable. Alternatively or additionally, input device 200 may include a suitable interface (which may be combined with communication interface 206) for receiving power from an external source.

Input device 200 includes a body that at least in part defines the form factor of the input device. In some examples, the body may resemble that of input device 100, having a cubical and substantially symmetrical geometry. This form factor, substantial symmetry, and potentially other factors such as rounded edges and a relatively small size in comparison to a typical human hand, may render input device 200 easily manipulatable throughout a range of orientations and conducive to not only a variety of use scenarios but also seamless and natural transitions among different use scenarios, such as the scenarios illustrated in FIGS. 1A-1D.

Input device 200 may include alternative or additional features not illustrated in FIG. 2. For example, input device 200 may include features arranged on its exterior surface that aid in its spatial tracking by an external image sensor such as image sensor 162. Such features may be substantially invisible to human sight but detectable in non-visible wavelengths such as infrared wavelengths. Another feature may include a light source (e.g., light-emitting diode) that provides visual feedback to a user indicating a state of power source 210, a mode in which an application is being controlled by input device 200, etc. Input device 200 may also include a device (e.g., a suitable actuator) for providing haptic feedback to a user.

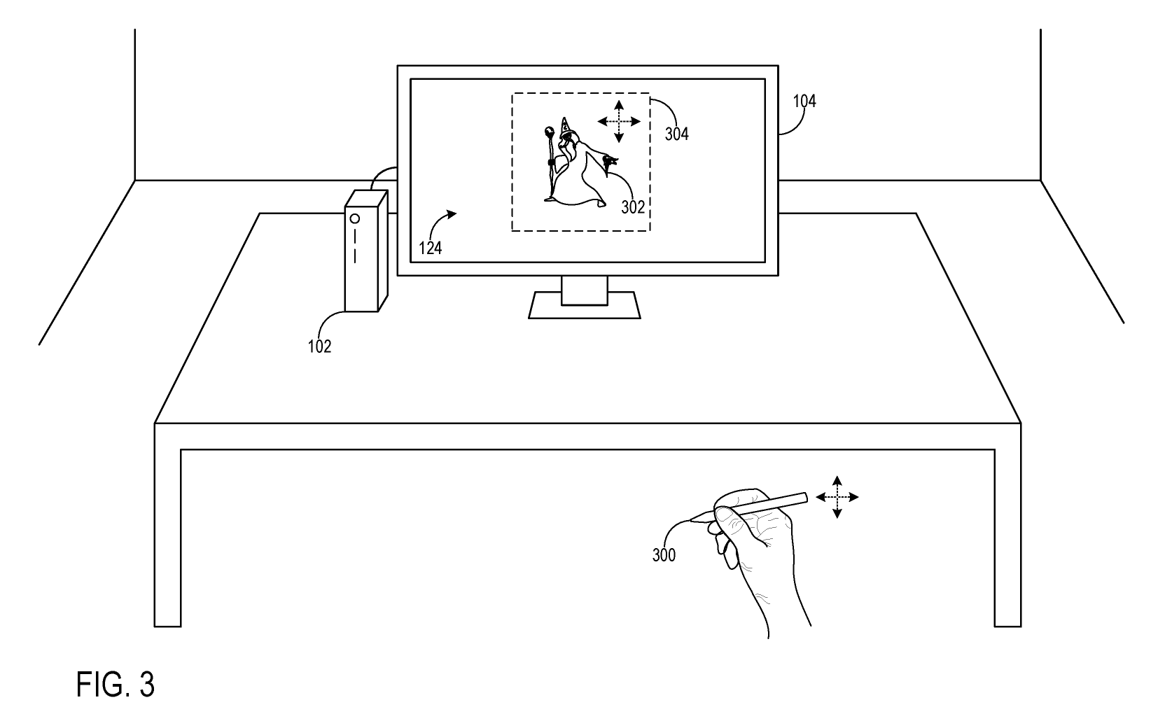

In other examples, the body of input device 200 may exhibit non-cubical geometries that confer different form factors to input device 200 and/or provide different functionality. To this end, FIG. 3 shows an example input device in the form of a stylus 300, which may represent one such implementation of input device 200 with a non-cubical form factor. Stylus 300 may sense its manipulation with six degrees-of-freedom, which may be used to control an application as described above in relation to input device 100. Stylus 300 may include other capabilities, such as the ability to apply active touch and/or hover input to a touch-sensitive device. To this end, stylus 300 may include suitable components for transmitting and/or receiving touch/hover input, such as a conductive tip configured to transmit/receive capacitive signals, logic for generating and interpreting capacitive signals, etc.

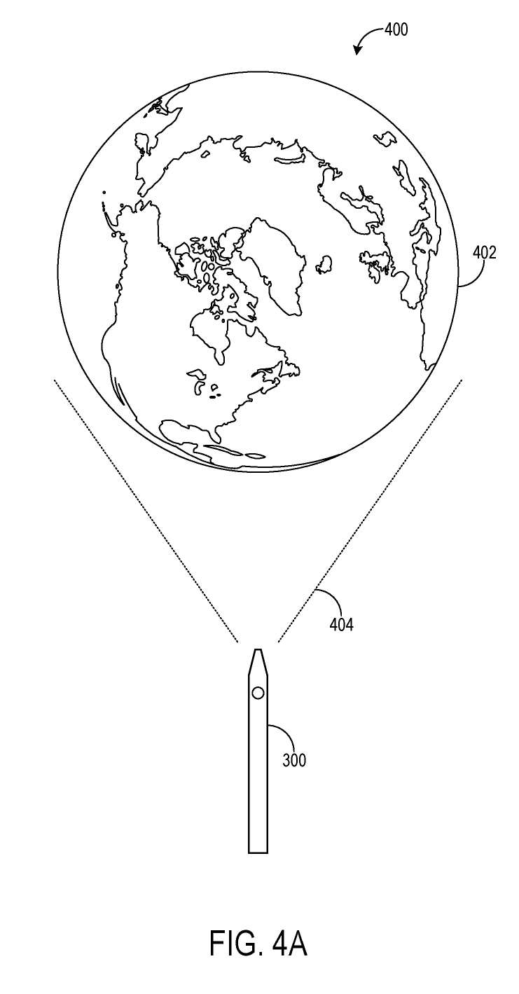

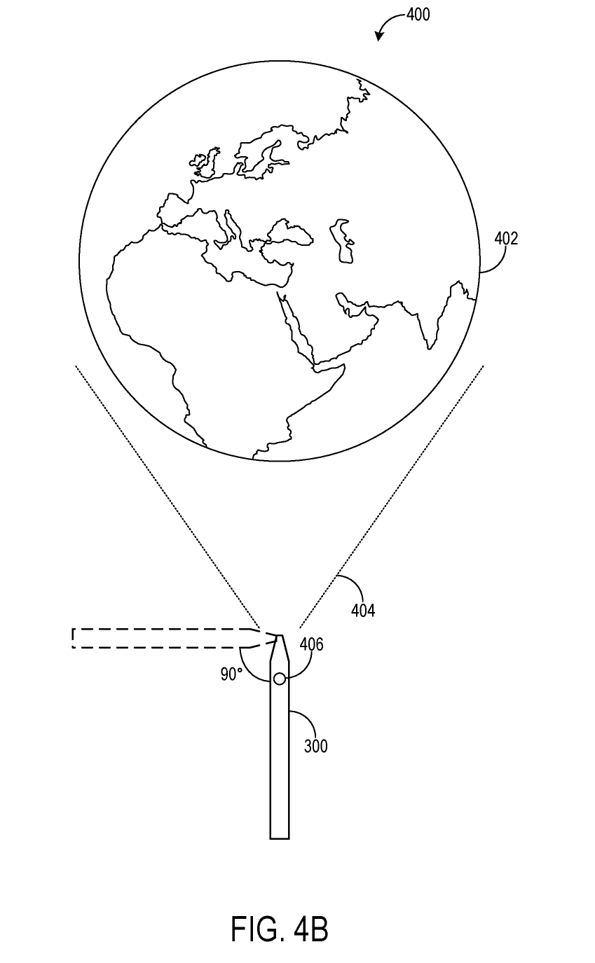

FIGS. 3-4B illustrate approaches designed to address issues that arise from interaction with and representation of three-dimensional graphical content. While shown and described with reference to stylus 300, these approaches are applicable to input device 100 and to yet other implementations of input device 200 and form factors.

In the example depicted in FIG. 3, a virtual character 302 is rendered on display 104. Virtual character 302 is three-dimensional, in that the virtual character can be manipulated (e.g., rotated) to reveal different aspects of the virtual character from different vantage points. Further, stylus 300 is operable to provide six DOF input enabling three-dimensional manipulation of virtual character 302. However, these properties—(1) the three-dimensional nature of virtual character 302, (2) the six DOF input capability of stylus 300, and (3) the capability of the stylus to three-dimensionally manipulate the virtual character—may not be apparent to a user, not only prior to manipulating the stylus but while manipulating the stylus.

To address these issues and apprise a user of the properties enumerated above, computing device 102 may alter the location and/or orientation of virtual character 302 in a generally restricted manner in response to manipulation of stylus 300. In qualitative and exemplary terms, this approach may render virtual character 302 with the apparent properties of slightly shaking or shimmying in response to significant motion of stylus 300, and of bouncing back to a default state once the stylus comes to relative rest. With motion of virtual character 302 reflected in this restrained way, the three-dimensional nature of the virtual character and stylus 300 can be conveyed to a user. However, enabling full three-dimensional control of virtual character 302 may be disabled until a suitable input enabling such control is received. Instead, the full three-dimensional control of virtual character 302 is previewed by altering its spatial characteristics in this restricted manner.

In more technical terms, changes to the location and orientation of virtual character 302 below an upper limit may be allowed, with changes above the limit being disallowed. An upper limit may be defined for each degree-of-freedom, or may be the same for one or more degrees-of-freedom. FIG. 3 shows a bounding box 304 generally illustrated the three-dimensional region in which movement of virtual character 302 may be confined in this mode. Further, the location and/or orientation of virtual character 302 may be returned to default values (e.g., those prior to manipulation of stylus 300) once motion of the stylus falls below a threshold in one or more degrees-of-freedom. In general, FIG. 3 represents approaches in which potentially unconstrained motion of an input device—e.g., motion in all six degrees-of-freedom—results in relatively constrained motion of graphical content of an application.

FIGS. 4A-4B illustrate how stylus 300 may be used to control a virtual camera in a three-dimensional scene 400. Three-dimensional scene 400 includes a virtual globe 402, which is three-dimensional in that the globe can be rotated to view different portions from different vantage points. While not shown in FIGS. 4A-4B, scene 400 may be rendered on a suitable display such as display 104 by a suitable computing device such as computing device 102, as part of executing an application (e.g., application 124).

In FIG. 4A, globe 402 is viewed from a first perspective that is selected according to the three-dimensional orientation of stylus 300. A view frustum 404 is associated with the tip of stylus 300, such that the perspective from which globe 402 is viewed may be adjusted by varying the orientation of stylus 300 and thereby the relative orientation between the view frustum and the globe. To illustrate this variance, FIG. 4B shows globe 402 viewed from a second perspective resulting from the rotation of stylus 300 and view frustum 404 by 90 degrees about a vertical axis (e.g., extending into the page of FIG. 4B). A different portion of globe 402 can then be perceived from the second perspective relative to the first perspective. While not illustrated in FIGS. 4A-4B, three-dimensional scene 400 may also support the variation of the perspective of globe 402 in response to translation of stylus 300 to thereby enable zoom into/out of the globe.

The camera control enabled by stylus 300 may utilize any suitable combination of user inputs. In one mode of control, the perspective of globe 402 may change in real-time as the orientation of stylus 300 changes. In another mode of control, the orientation of stylus 300 may not effect changes to the perspective until a suitable user input is received. In this mode, a user may manipulate the orientation of stylus 300 until a desired orientation corresponding to a desired perspective of globe 402 is achieved, and supply the user input to effect viewing from this perspective. The user input may include a single or double tap of a button 406 provided on stylus 300, for example. Further, any suitable type of camera control may be implemented using stylus 300, which may include the control of a third-person camera or a first-person camera. For example, stylus 300 may be operated as a mechanism of physically manipulating a gaze vector, which may be a virtual gaze vector provided as input to an application (potentially in lieu of a sensed user gaze vector).

One or more of the input devices described herein may be used in combination to enhance user interaction with a computing device. As described above with reference to FIG. 1D, image sensor 162 may be used to implement or refine six DOF tracking of input device 100 (as well as input device 200 and 300). Further, input device 100 may be used in conjunction with stylus 300—for example, the stylus may be used to apply gestural input proximate to or in contact with the input device (e.g., to apply two-dimensional imagery to a three-dimensional object manipulated via the input device). Yet other device combinations are possible.

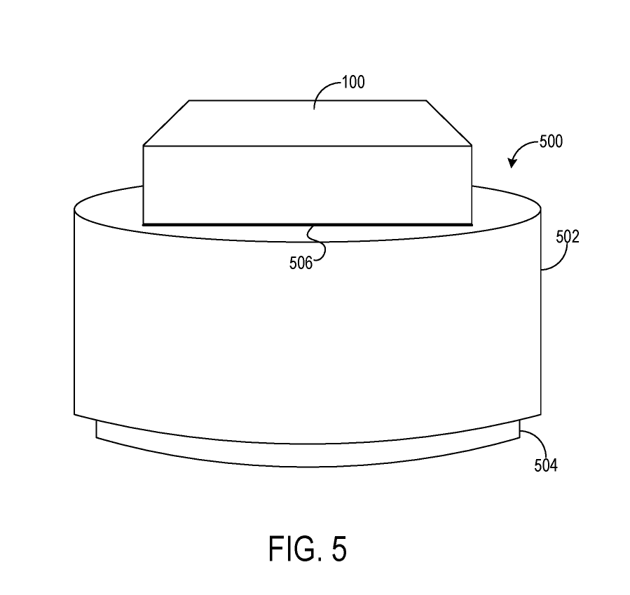

FIG. 5 shows an example input device 500 configured for use with input device 100. Input device 500 may be operable to provide a variety of inputs to a host device such as computing device 102. For example, input device 500 may include a body 502 that is rotatable to provide rotational and/or other input, and/or that is depressible (e.g., to provide input for selecting elements in a graphical user input) relative to a base 504. Further, input device 500 may provide input detectable by a touch/hover sensor—for example, the input device may produce a capacitive pattern via base 504 that is detectable by a capacitive sensor. Input device 500 also includes a recess 506 configured to releasably secure input device 100. As one example, spatial sensing of input devices 100 and 500 may utilize an IMU for rotation in three degrees-of-freedom, in combination with dead reckoning using acceleration values for relative positioning.

The combination of input device 100 and input device 500 may enable the provision of any suitable inputs to a host device. For example, the position of input device 500 on a display may be used to specify a target in display space to which input generated by manipulating input device 100 is applied. As another example, the rotational orientation of body 502 may define one or more axes of rotation to which input generated by manipulating input device 100 is constrained. As another example, a user may concurrently manipulate input devices 100 and 500 to increase control over graphical content—e.g., the devices may enable the scale and rotational orientation of a virtual object to be simultaneously varied.

Input to the host device may vary based on the state of input device 100 and/or 500—for example, different inputs/modes/interactions may be carried out whether (1) input device 100 is held in air; (2) input device 100 is secured in input device 500, with input device 500 resting on a surface other than that of a display; (3) input device 100 is secured in input device 500, with input device 500 resting on a display surface; and (4) input device 100 rests on a surface. These and/or other conditions may effect switching between constrained and unconstrained manipulation of graphical content, switching between three-dimensional manipulation and menu interactions (e.g., input applied to two-dimensional user interface elements), switching between object and camera manipulation, switching between other modes or tools, etc. Further, these and other modes of control may be effected when using input device 500 in combination with stylus 300. As one example of such combination, input device 500 may be used to specify an origin in display space, with stylus 300 being used to specify a destination in display space—e.g., for copying and pasting content in a word processing application or image editing application.

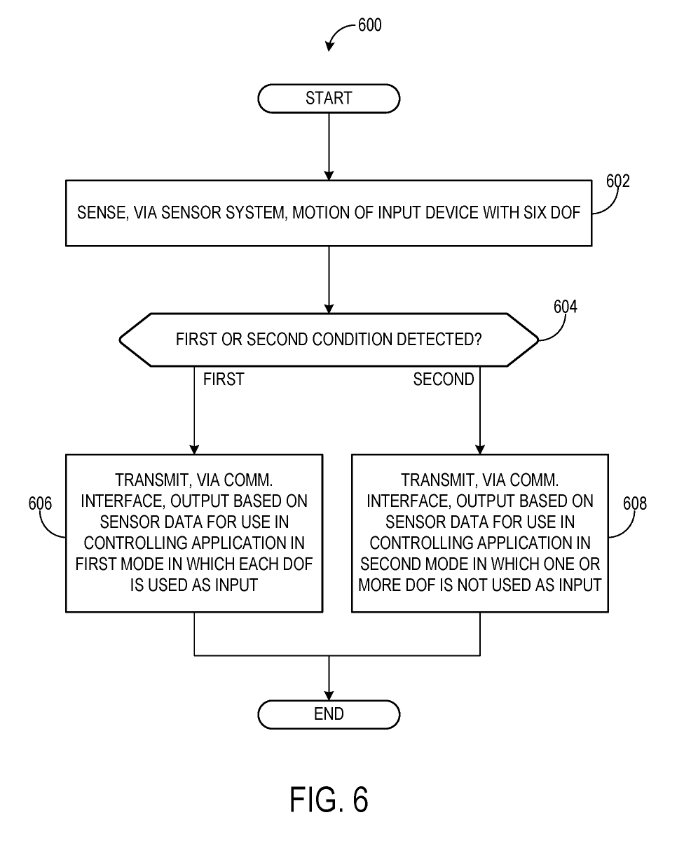

FIG. 6 shows a flowchart illustrating an example method 600 of controlling an application in different modes using a six DOF input device. Method 600 may be implemented on one or more of input device 100, 200, 300, for example.

At 602, method 600 includes sensing, via a sensor system of the input device, motion of the input device with six degrees-of-freedom. The six degrees-of-freedom may include three degrees of translational freedom and three degrees of rotational freedom.

At 604, method 600 includes determining whether a first condition or a second condition is detected. If the first condition is detected (FIRST), method 600 proceeds to 606. If the second condition is detected (SECOND), method 600 proceeds to 608. The first condition may include variation of each of the six degrees-of-freedom, and the second condition may include one or more of the six degrees-of-freedom being constrained. The input device may detect the first and/or second condition, while in other examples a host device executing the application may detect the first and/or second condition. As examples, in the second mode, the input device may undergo two-dimensional translation constrained to a surface or rotation about a single axis.

At 606, method 600 includes transmitting, via a communication interface of the input device, output based on sensor data from the sensor system for use in controlling an application in a first mode in which each of the six degrees-of-freedom is used as input.

At 608, method 600 includes transmitting, via a communication interface of the input device, output based on sensor data from the sensor system for use in controlling an application in a second mode in which one or more of the six degrees-of-freedom is not used as input.

In some embodiments, the methods and processes described herein may be tied to a computing system of one or more computing devices. In particular, such methods and processes may be implemented as a computer-application program or service, an application-programming interface (API), a library, and/or other computer-program product.

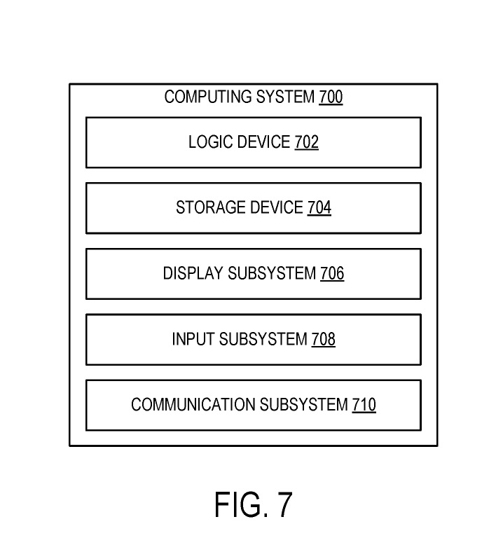

FIG. 7 schematically shows a non-limiting embodiment of a computing system 700 that can enact one or more of the methods and processes described above. Computing system 700 is shown in simplified form. Computing system 700 may take the form of one or more personal computers, server computers, tablet computers, home-entertainment computers, network computing devices, gaming devices, mobile computing devices, mobile communication devices (e.g., smart phone), and/or other computing devices.

Computing system 700 includes a logic machine 702 and a storage machine 704. Computing system 700 may optionally include a display subsystem 706, input subsystem 708, communication subsystem 710, and/or other components not shown in FIG. 7.

Logic machine 702 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 704 includes one or more physical devices configured to hold instructions executable by the logic machine to implement the methods and processes described herein. When such methods and processes are implemented, the state of storage machine 704 may be transformed—e.g., to hold different data.

Storage machine 704 may include removable and/or built-in devices. Storage machine 704 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 704 may include volatile, nonvolatile, dynamic, static, read/write, read-only, random-access, sequential-access, location-addressable, file-addressable, and/or content-addressable devices.

It will be appreciated that storage machine 704 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 702 and storage machine 704 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 700 implemented to perform a particular function. In some cases, a module, program, or engine may be instantiated via logic machine 702 executing instructions held by storage machine 704. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 706 may be used to present a visual representation of data held by storage machine 704. This visual representation may take the form of a graphical user interface (GUI). As the herein described methods and processes change the data held by the storage machine, and thus transform the state of the storage machine, the state of display subsystem 706 may likewise be transformed to visually represent changes in the underlying data. Display subsystem 706 may include one or more display devices utilizing virtually any type of technology. Such display devices may be combined with logic machine 702 and/or storage machine 704 in a shared enclosure, or such display devices may be peripheral display devices.

When included, input subsystem 708 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 710 may be configured to communicatively couple computing system 700 with one or more other computing devices. Communication subsystem 710 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 700 to send and/or receive messages to and/or from other devices via a network such as the Internet.

Another example provides an input device comprising a body, a sensor system configured to sense motion of the input device with six degrees-of-freedom including three degrees of translational freedom and three degrees of rotational freedom, a communication interface, and a controller configured to transmit, via the communication interface, output based on sensor data from the sensor system for use in controlling an application in a first mode in which each of the six degrees-of-freedom is used as input, the application being controlled in the first mode in response to detecting a first condition, and transmit, via the communication interface, output based on sensor data from the sensor system for use in controlling the application in a second mode in which one or more of the six degrees-of-freedom is not used as input, the application being controlled in the second mode in response to detecting a second condition different from the first condition. In such an example, the first condition may include variation of each of the six degrees-of-freedom. In such an example, the second condition may include one or more of the six degrees-of-freedom being constrained. In such an example, the controller alternatively or additionally may be configured to detect one or both of the first condition and the second condition. In such an example, a host device executing the application may be configured to detect one or both of the first condition and the second condition. In such an example, the output alternatively or additionally may control one or both of a three-dimensional location and a three-dimensional orientation of graphical content in the application. In such an example, the output alternatively or additionally may control a virtual camera of the application. In such an example, in the second mode, the input device may undergo two-dimensional translation constrained to a surface. In such an example, in the second mode, the input device may undergo rotation about a single axis. In such an example, the application alternatively or additionally may be controlled based on gestural input applied to the input device. In such an example, the application alternatively or additionally may be controlled based on output from an image sensor configured to track the input device. In such an example, the body may include a cubical form factor. In such an example, the body may be configured as a stylus.

Another example provides, at an input device, a method, comprising sensing, via a sensor system, motion of the input device with six degrees-of-freedom including three degrees of translational freedom and three degrees of rotational freedom, transmitting, via a communication interface, output based on sensor data from the sensor system for use in controlling an application in a first mode in which each of the six degrees-of-freedom is used as input, the application being controlled in the first mode in response to detecting a first condition, and transmitting, via the communication interface, output based on sensor data from the sensor system for use in controlling an application in a second mode in which one or more of the six degrees-of-freedom is not used as input, the application being controlled in the second mode in response to detecting a second condition. In such an example, the first condition may include variation of each of the six degrees-of-freedom. In such an example, the second condition may include one or more of the six degrees-of-freedom being constrained. In such an example, the application alternatively or additionally may be controlled based on gestural input applied to the input device. In such an example, the output may be produced as a result of unconstrained motion of the input device, and may result in constrained motion of graphical content of the application.

Another example provides an input device, comprising a body, a sensor system configured to sense motion of the input device with six degrees-of-freedom including three degrees of translational freedom and three degrees of rotational freedom, a communication interface, and a controller configured to transmit, via the communication interface, output based on sensor data from the sensor system for use in controlling an application in a first mode in which each of the six degrees-of-freedom is used as input, the application being controlled in the first mode in response to detecting a first condition in which each of the six degrees-of-freedom varies, and transmit, via the communication interface, output based on sensor data from the sensor system for use in controlling the application in a second mode in which one or more of the six degrees-of-freedom is not used as input, the application being controlled in the second mode in response to detecting a second condition in which one or more of the six degrees-of-freedom is constrained. In such an example, the output for use in controlling the application in the second mode may be produced as a result of constrained motion of the input device.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. An input device, comprising:
a body;
a sensor system configured to sense motion of the input device with six degrees-of-freedom including three degrees of translational freedom and three degrees of rotational freedom;
a communication interface; and
a controller configured to:
transmit, via the communication interface, output based on sensor data from the sensor system for use in controlling an application in a first mode in which each of the six degrees-of-freedom is used as input, the application being controlled in the first mode in response to detecting a first condition; and
transmit, via the communication interface, output based on sensor data from the sensor system for use in controlling the application in a second mode in which one or more of the six degrees-of-freedom is not used as input, the application being controlled in the second mode in response to detecting a second condition different from the first condition.

2. The input device of claim 1, where the first condition includes variation of each of the six degrees-of-freedom.

3. The input device of claim 1, where the second condition includes one or more of the six degrees-of-freedom being constrained.

4. The input device of claim 1, where the controller is configured to detect one or both of the first condition and the second condition.

5. The input device of claim 1, where a host device executing the application is configured to detect one or both of the first condition and the second condition.

6. The input device of claim 1, where the output controls one or both of a three-dimensional location and a three-dimensional orientation of graphical content in the application.

7. The input device of claim 1, where the output controls a virtual camera of the application.

8. The input device of claim 1, where, in the second mode, the input device undergoes two-dimensional translation constrained to a surface.

9. The input device of claim 1, where, in the second mode, the input device undergoes rotation about a single axis.

10. The input device of claim 1, where the application is further controlled based on gestural input applied to the input device.

11. The input device of claim 1, where the application is further controlled based on output from an image sensor configured to track the input device.

12. The input device of claim 1, where the body includes a cubical form factor.

13. The input device of claim 1, where the body is configured as a stylus.

14. At an input device, a method, comprising:
sensing, via a sensor system, motion of the input device with six degrees-of-freedom including three degrees of translational freedom and three degrees of rotational freedom;
transmitting, via a communication interface, output based on sensor data from the sensor system for use in controlling an application in a first mode in which each of the six degrees-of-freedom is used as input, the application being controlled in the first mode in response to detecting a first condition; and
transmitting, via the communication interface, output based on sensor data from the sensor system for use in controlling an application in a second mode in which one or more of the six degrees-of-freedom is not used as input, the application being controlled in the second mode in response to detecting a second condition.

15. The method of claim 14, where the first condition includes variation of each of the six degrees-of-freedom.

16. The method of claim 14, where the second condition includes one or more of the six degrees-of-freedom being constrained.

17. The method of claim 14, where the application is further controlled based on gestural input applied to the input device.

18. The method of claim 14, where the output is produced as a result of unconstrained motion of the input device, and results in constrained motion of graphical content of the application.

19. An input device, comprising:
a body;
a sensor system configured to sense motion of the input device with six degrees-of-freedom including three degrees of translational freedom and three degrees of rotational freedom;
a communication interface; and
a controller configured to:
transmit, via the communication interface, output based on sensor data from the sensor system for use in controlling an application in a first mode in which each of the six degrees-of-freedom is used as input, the application being controlled in the first mode in response to detecting a first condition in which each of the six degrees-of-freedom varies; and
transmit, via the communication interface, output based on sensor data from the sensor system for use in controlling the application in a second mode in which one or more of the six degrees-of-freedom is not used as input, the application being controlled in the second mode in response to detecting a second condition in which one or more of the six degrees-of-freedom is constrained.

20. The input device of claim 19, where the output for use in controlling the application in the second mode is produced as a result of constrained motion of the input device.
